(19) United States
(12) Patent Application Publication
(10) Pub. No.: US 2007/0136744 A1
(43) Pub. Date: Jun. 14, 2007

(54) System, device and method for collaborative zapping

(75) Inventors: David Peter Louis Simons, Eindhoven (NL); Mariana Vassileva Nikolova, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/572,614

(22) PCT Filed: Sep. 13, 2004
(86) PCT No.: PCT/IB04/51743

§ 371 Date: Mar. 17, 2006

(30) Foreign Application Priority Data
Sep. 22, 2003 (EP) 03103475.4

(51) Int. Cl. H04N 7/10; H04N 7/025; G06F 13/00; H04N 5/445; G06F 3/00

(52) U.S. Cl. 725/34; 725/35; 725/45; 725/46

(57) ABSTRACT

The invention relates to a system of apparatuses for receiving content items, e.g. television sets, a method of controlling the apparatuses for receiving content items and a remote control unit for communicating with the apparatus for receiving content items. The system comprises selection control means (120, 130, 140) for controlling the apparatuses to select automatically the same content items for users having substantially the same user preferences. The selection control means may be located at the head-end of a cable network. The selection control means may comprise a selection control circuit (120), a user profiling unit (130) and/or an operator interface (140). Selection control data may be generated for transmission to the receivers, for example, by using a collaborative user profile for users with the same user preferences and EPG data.

The invention relates to a system of apparatuses for receiving content items, e.g. television sets, a method of controlling the apparatuses for receiving content items and a remote control unit for communicating with the apparatus for receiving content items.

Document U.S. Pat. No. 6,493,688 describes a television set having a tuner for receiving TV programs, user profiling means for obtaining a user profile and zap control means. The zap control means defines a zap-circle of channels which contains only channels broadcasting a program with a positive rating in accordance with the user profile. The channels in the zap-circle may be ordered in accordance with the channel preset numbers or the respective positive rating. Whenever, a program changes, i.e. the program finishes, the zap-circle is sorted again and the channels may be included or excluded from the circle depending on the rating of programs broadcast on the channels at certain moment. Zapping through the zap-circle is realized by using conventional zap-keys on a remote control unit, e.g. channel up/down buttons. The user profile may be transferred to the remote control unit for controlling the TV set in the above-described manner.

In the known television set, the user has to select the programs manually. The known method of zapping through channels is not suitable when there is a large number of TV channels because the number of TV channels included in the zap-circle may be too large. Thus, zapping through the channels may be very time-consuming. Moreover, it may be very cumbersome for the user to rate combinations of programs and channels in the case of a large number of channels.

It is an object of the present invention to obviate the drawbacks of the prior art and to provide apparatuses for receiving content items which perform selection of the content items with minimal input from a user.

The object is realized in that the system of the apparatuses for receiving content items comprises selection control means for controlling the apparatuses to select automatically the same content items for users having substantially the same user preferences.

According to the present invention, the apparatus for receiving content items is arranged to provide the user with content items in accordance with user interests, and automatically select content items without any user input. The system of such apparatuses comprises selection control means for controlling the apparatuses to select automatically the same content items. The apparatuses provide the same content items to users who have substantially the same user preferences, i.e. users having similar interests with respect to the content. The apparatuses in the system may be arranged to obtain selection control data from selection control means to select the content items accordingly. The selection control means may be arranged to obtain, for example, a list of content items for the sequential selection and correspondingly generate the selection control data. The system according to the present invention has an advantage that the apparatuses may be simpler than the TV set known from U.S. Pat. No. 6,493,688, and the apparatuses may not comprise any means such as the user profiling means and the zap control means which need to be incorporated in the known TV set.

The system may comprise TV receivers for receiving TV programs, wherein the users of the TV receivers have similar user preferences. According to the present invention, the TV receivers may be arranged to stay tuned to programs of interest, and automatically switch between the programs. Thus the users do have to switch to the programs of interest manually.

In one of the embodiments of the invention, the selection control means is arranged to control apparatuses to select the content items simultaneously. For example, the selection control means may instruct the apparatuses to select synchronously every content item at a particular moment of time. Alternatively, the apparatuses may be controlled to select a first content item at the same moment of time and subsequently the same content items, as the same content items have the same duration. Thus, the users may be presented with the same content items at the same time.

In a further embodiment, the selection control means is arranged to control the apparatuses to select a first content item and a second content item, wherein the first and second content items are sequential in accordance with the user preferences. For example, the first and second content items may be content items related to the same context, latest TV news programs broadcast at different times on different channels, movies of the same producer, songs of the same singer or band, etc.

In a further embodiment, the selection control means is arranged to control the apparatuses to select the second content item in response to an interruption of receiving the first content item, wherein the first and second content items are related to the same broadcast live event. For example, the first TV program related to a broadcast live event may be interrupted by a commercial. The apparatus may be arranged to select automatically a second TV program, e.g. being broadcast on another TV channel, to avoid the undesirable break in showing the live event to the user. For instance, TV live programs of Formula 1 racing, which are likely to be broadcast on multiple channels, are often interrupted by commercials.

In another example, the selection control means is arranged to control the apparatuses to select the second content item being a continuation of the first content item. The apparatuses may be controlled to select a first part of a TV program on a first channel, and a second part of the TV program on a second channel. The first and second parts may be logically subsequent parts of a TV show program.

In a further embodiment, the system of the present invention further comprises user profiling means for obtaining a collaborative user profile of the users having substantially the same user preferences, and a control schedule of subsequent content items, the selection control means being arranged to obtain said control schedule to control the apparatuses accordingly. The collaborative user profile may be used to obtain the control schedule. This may be performed by a single user profiling means. It is an advantage of the present invention that no individual user profiling means for each apparatus are necessary as in U.S. Pat. No. 6,493,688.

According to U.S. Pat. No. 6,493,688, a set of TV programs being currently broadcast, i.e. being broadcast at some moment of time, is arranged in the zap-circle. In contrast to this prior art, the user profiling means of the present invention generates a schedule of the content items to be selected sequentially.

In a further embodiment, the selection control means is arranged to obtain an input of an operator at a side of the selection control means being remote from the apparatuses, the operator instructing the selection control means to control the apparatuses accordingly. For example, an operator at a side of a cable TV provider, a satellite TV provider or a TV broadcaster may be provided with an overview of programs broadcast on different TV channels. Based on the overview, the operator may take a decision about switching between the TV programs for the users having similar user preferences. For example, the users may subscribe to such a service when they do not want to watch commercials. In the framework of the service, the operator of a particular TV channel broadcaster may provide, for example, his input to the selection control means to control the apparatuses of the users subscribed to the service to select another TV channel while the commercial is being broadcast on that particular channel. It may be advantageous when the operator manually operates, i.e. instructs, the selection control means in real-time rather than having the user profiling means provide the control schedule to the selection control means based on the collaborative user profile, because the work of the operator may have a higher quality. In another example, the user profiling means may first be used to generate the control schedule, and then the operator may be enabled to correct and/or approve the control schedule to be provided to the selection control means for controlling the apparatuses.

According to the present invention, an apparatus for receiving content items comprises means for receiving selection control data to select automatically the same content items as another apparatus for receiving content items, with users of the apparatuses having substantially the same user preferences. The apparatus may receive the selection control data from the selection control means at another location. The apparatus is arranged to provide automatically the user with the same content items as other apparatuses for the users with similar user preferences.

The present invention also describes a remote control unit for communicating with an apparatus for receiving content items, wherein the remote control unit is arranged to control the apparatus to select automatically the same content items as another apparatus for receiving content items, with users of the apparatuses having substantially the same user preferences.

The object of the invention is also realized in that a method of controlling apparatuses for receiving content items comprises a step of controlling the apparatuses to select automatically the same content items for users having substantially the same user preferences. The method describes the operation of the system of the apparatuses described above.

These and other aspects of the invention will be further described with reference to the accompanying drawings, wherein:

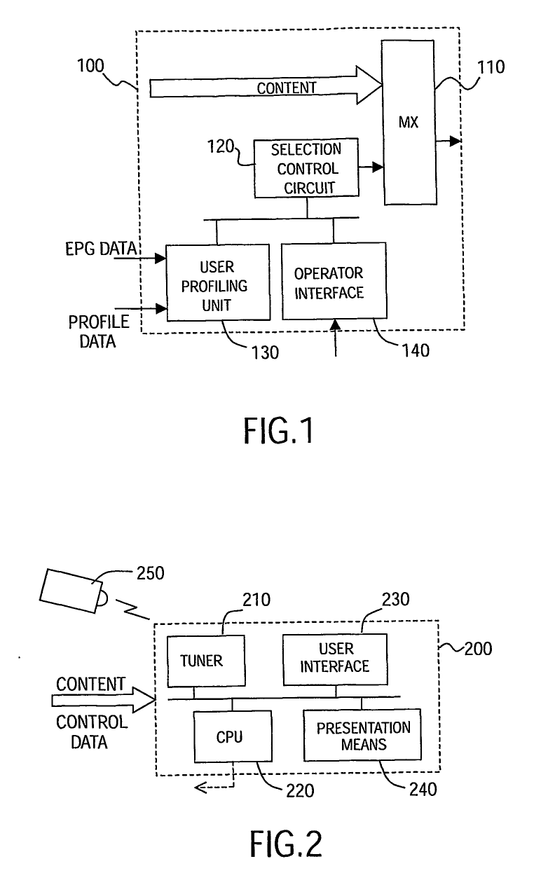

FIG. 1 shows a functional block diagram of an embodiment of a transmitter according to the invention;

FIG. 2 shows a functional block diagram of an embodiment of a receiver according to the invention;

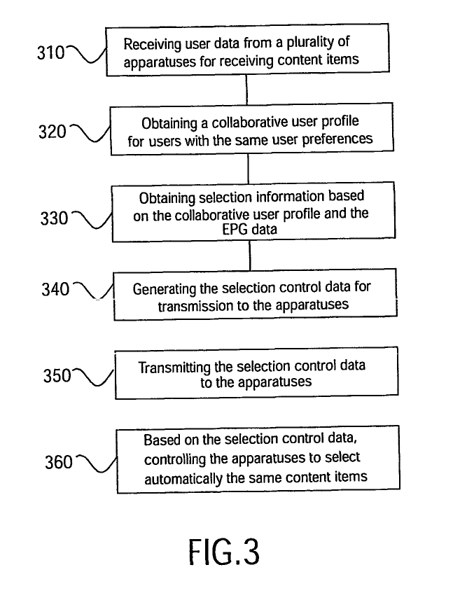

FIG. 3 shows an embodiment of the method of the present invention.

The system according to the invention may comprise a transmitter for transmitting content items and apparatuses, i.e. receivers, for receiving the content items. For instance, the transmitter and the apparatuses may be located in a cable network. FIG. 1 shows an embodiment of a transmitter 100 comprising selection control means for controlling the apparatuses to select automatically the same content items. The transmitter may comprise a multiplexer 110 for multiplexing content data and selection control data. For example, the transmitter may be arranged to receive or locally obtain video signals, e.g. television signals, which are further encoded in accordance with the MPEG-2 video coding standard into the multimedia content data bitstreams. In another example, the content data may be already available as MPEG-2 elementary bitstreams.

The transmitter may further comprise a selection control circuit 120 arranged to generate the selection control data. The selection control circuit may be coupled to a user profiling unit 130 and/or an operator control interface 140, which may be arranged to provide the selection control circuit with selection information suitable to enable the receivers, e.g. TV sets, to select automatically content items. The selection information may be a set of content items, e.g. a simple list of the content items, a zapping script, e.g. an XML script, or other meta-data.

The set of content items may be obtained for users having similar preferences regarding the content. For instance, such users may have similar preferences to genres of movies, they may prefer the same content provider, or they may simply like watching the same TV channel.

The transmitter may be arranged to interrogate the receivers for identifying the users with similar user preferences. The receiver may be arranged to provide the user profiling unit with user data indicating user preferences, for example, information about the user's historical television viewing activities, user demographic information such as the user's age, sex, profession, etc, simply the identification of the TV channel which the user is currently watching, etc.

The user profiling unit may be arranged, for example, to obtain a collaborative user profile of users having similar user preferences. The user profiling unit may receive the collaborative user profile already available or generate the collaborative profile using known methods. The collaborative user profile may be established on the basis of similarity in profile between the user and other users and between the content indexed in the user's profile and other content in the database. Also, the information about historical television viewing activities of different users may be compared. A similarity between the user's implicit and/or explicit ratings of the content items and other users' ratings may be correlated. Based on the correlations, a subset of users having similar user preferences may be selected.

In one of the embodiments of the present invention, the receiver may be arranged to enable the user to subscribe to a certain user profile. For example, a plurality of user profiles, e.g. stereotype user profiles or community user profiles may be available at the user profiling unit for the user to subscribe to.

After the collaborative user profile or other data indicating similar user preferences of a group of users is obtained, the user profiling unit may analyze, for example, EPG data (Electronic Programme Guide) for automatically establishing the selection information. The EPG data may be data records regarding broadcast TV programs. Each available program may have a single corresponding data record containing information about the program such as its channel, its starting and ending times, its title, names of starring actors, whether closed-captioning and stereo are available, and perhaps a brief description of the program. These data spanning a period, e.g. two weeks, are typically pre-formatted once at the server, e.g. the cable system's head-end, for broadcast by the cable system. The user profiting unit may be arranged to filter the EPG data using the collaborative user profile to form a control schedule of subsequent programs. The obtained schedule of the programs may comprise TV programs broadcast at certain moments on different TV channels. In another example, the user profiling unit may be arranged to establish the control schedule of the content items other than the TV programs. For example, the content items may be movies or another recorded content stored in a media content database (not shown) from which the receivers can receive the content. The content items in the database may be indexed and assigned unique identifiers with which the transmitter can instruct the receivers to receive the respective content items from the database. To this end, the identifiers of the content items may be included in the selection information.

An example of simple selection information generated by the user profiling unit is shown in the Table below.

| | Content item | |
|---|---|---|
| Time | descriptor | Source |
| 19:00 | TV program 1 | TV broadcast/Channel 1 |
| 19:45 | TV program 2 | TV broadcast/Channel 7 |
| 20:25 | Content item 3 | DVD player |
| 22:00 | Content item 4 | On-demand source |

The selection information in the Table above shows content items from different sources but form a continuous schedule. When the receivers receive such selection information and automatically switch between content items according to the selection information, the users may simultaneously be presented with the same content items. In this way, the group of users with similar user preferences stays tuned to the programs of interest.

Based on additional information about the content items, for example, the summary of the TV program provided in the EPG data, the user profiling unit may be arranged to generate the selection information in which the content items are composed sequentially in accordance with the user preferences. The consecutive content items may relate to the same producer, the same theme or context, the same actor of the movies, etc.

The user profiling unit may put in the selection information the sequential content items, one of which is a continuation of the content item preceding in the sequence. For example, in the Table shown above, TV program 1 may be a movie “Indiana Jones and the Temple of Doom”, and TV program 2 may be a movie “Indiana Jones and the Last Crusade”. The programs are from the same series of stories, and the users may like both TV programs. The relationship between these programs may easily be found from their titles, starring actors, similar stories, etc. Entertainment shows, like “Idols”, which start on one TV channel and continue for the second part on another TV channel, are similar examples of such content items.

The operator interface 140 may also be used for generating the selection information. The operator interface may be arranged to provide the operator with an overview of TV programs broadcast on respective TV channels, content items stored in various databases, etc. For example, the broadcast TV programs, EPG data formatted in an EPG grid, media database interfaces for browsing the stored content items may be shown to the operator on dedicated video displays. The EPG grid is typically shown with rows representing a particular broadcast channel or cable channel and columns representing a particular time slot, e.g., 30-minute time slots. Multiple rows and multiple columns can be displayed on the screen simultaneously.

The operator interface may further comprise a screen on which, for example, a graphical user interface enabling the operator to enter the selection information in a format as shown in the Table, and a console for actually entering the selection information. In the television, various automatic commercial detectors are known. However, such detectors are sometimes not reliable and might not detect some commercials. According to the present invention, the operator interface may be adapted to allow the operator to input manually the instruction to the operator interface for generating the desirable selection information, e.g. to switch the receivers to another TV channel.

In one of the embodiments of the present invention, the operator may also be a user who shares his selection with other users, e.g. by uploading it to the selection control circuit 120.

After the selection control unit obtains the selection information, the selection control data is generated and applied to the multiplexer. The selection control data may be transmitted with a content item, for example, as described in U.S. Pat. No. 5,633,683. A program comprising elementary bitstreams in accordance with the MPEG2 standard is transmitted in packets and a programs association table is used for joining the data streams. The selection information may be presented by using a descriptor in the program table, in a corresponding syntax.

The present invention is not limited to the embodiment shown in FIG. 1. In another embodiment of the system, the selection control means may be accessible for the apparatuses for receiving content items via the Internet or other networks. For example, the selection control means may be realized by using an Internet server executing a computer program enabling said selection control means. The receivers may comprise communication means allowing bi-directional communication via the Internet with the selection control means.

The system of the present invention may not necessarily comprise the transmitter at the head-end of the cable network and the receivers at the back-end of the cable network, but some parts of the transmitter may also be at the receiver's side, or the transmitter may be implemented in another manner.

With reference to FIG. 2, an embodiment of the apparatus, i.e. the receiver, for receiving the content items is shown. The receiver 200 may comprise a tuner 210, a microprocessor 220 and a timer (not shown). The tuner 210 is arranged to receive the content items and the selection control data via an electric conductor, fiber-optic cable, satellite delivery, mobile telephone network delivery, data carrier or in any other way.

In a manner known from U.S. Pat. No. 5,633,683, the microprocessor may obtain the selection information from the received data, and control the tuner to receive automatically the content item as indicated in the selection information. To ensure that the tuner receives the content item at the correct time, and synchronously with other receivers, the timer may be synchronized with the selection control unit of the transmitter or corrected in the same manners as the timers of the other receivers.

The receiver 200 may be coupled to various content sources for receiving the instructed content items. The receiver may also comprise a user interface 230 and a content presentation means 240. The user may use the user interface, for example, realized by a computer program interacting with the user via the presentation means, e.g. a conventional display, and a keyboard (not shown) or a remote control unit 250, for subscribing to the user profiles stored in the user profiling unit, as described above. The microprocessor may also be arranged to provide the user profiling unit 130 with the user data such as the user's zapping history.

The selection information transmitted to the receiver 100 may be presented as an XML script. The CPU may be arranged to parse and execute the XML script in a known manner.

In one of the embodiments of the present invention, the receiver may be arranged to obtain the selection control data via the remote control unit 250. The remote control unit, e.g., the programmable remote controller i-Pronto manufactured by Philips, may be arranged to download the selection control data via the Internet. The remote control unit may be arranged to process the selection control data in the same manner as the microprocessor 220. Such a remote control is usually capable of controlling the tuner 210. Thus, the remote control unit can control the TV set to automatically start zapping between the TV channels which are of interest to the user.

In a further embodiment, a dedicated device such as a mobile phone may be arranged to obtain the selection control data from the selection control unit. Using a control protocol, e.g., a UPnP protocol supported by networked TV sets, the dedicated device can control the tuner 210 accordingly. The mobile phone may have Bluetooth communication means for controlling the tuner.

The content presentation means may be at least one of a TV set display, a video recorder, a DVD player, a home cinema system, a portable audio player, a portable video player or a mobile phone display.

In one of the embodiments of the present invention, the content presentation means is a video recorder configured to operate in a “follow a schedule” mode. The recorder receives the selection control data and uses the selection control data to record automatically TV programs indicated in the selection control data. Thus, show/TV programs broadcast on different channels are automatically recorded, on the basis of the selection control data, and the user's input is not required. In the known video recorders, when a user programs the video recorder to record TV programs scattered over N (N>1) channels, the user has to manually enter N entities in a recording list of the video recorder. This manual input may be very time-consuming when the number of channels is large.

FIG. 3 shows an embodiment of the method of the present invention. The method comprises a step of controlling the apparatuses to select automatically the same content items for users having substantially the same user preferences. The method describes the operation of the system according to the present invention. At step 310, the user data is received from a plurality of the apparatuses for receiving content items. At step 320, the collaborative user profile for users with the same preferences for the content items is obtained by the user profiling unit 130. At step 330, the selection information is obtained by the user profiling unit based on the collaborative user profile and, for example, the EPG data, and applied to the selection control circuit 120. At step 340, the selection control data is generated for transmission to the receivers. At step 350, the selection control data is transmitted to the apparatuses, e.g. by means of the transmitter 100. Based on the received selection control data, the apparatuses are controlled to select automatically the same content items for the users of their “community”, at step 360.

The various program products may implement the functions of the device and method of the present invention and may be combined in several ways with the hardware or located in different other devices. Variations and modifications of the described embodiment are possible within the scope of the inventive concept. Thus, for example, use of the verb ‘to comprise’ and its conjugations does not exclude the presence of elements or steps other than those defined in a claim. The invention can be implemented by means of hardware comprising several distinct elements, and by means of a suitably programmed computer. In the device claim enumerating several means, several of these means can be embodied by one and the same item of hardware.

1. A system of apparatuses (200) for receiving content items, the system comprising selection control means (120, 130, 140) for controlling the apparatuses to select automatically the same content items for users having substantially the same user preferences.

2. The system of claim 1, wherein the selection control means is arranged to control the apparatuses to select the content items simultaneously.

3. The system of claim 1, wherein the selection control means is arranged to control the apparatuses to select a first content item and a second content item, wherein the first and second content items are sequential in accordance with the user preferences.

4. The system of claim 3, wherein the selection control means is arranged to control the apparatuses to select the second content item in response to an interruption of receiving the first content item, wherein the first and second content items are related to the same broadcast live event.

5. The system of claim 3, wherein the selection control means is arranged to control the apparatuses to select the second content item being a continuation of the first content item.

6. The system of claim 1, further comprising user profiling means (130) for obtaining a collaborative user profile of the users having substantially the same user preferences, and a control schedule of subsequent content items, the selection control means being arranged to obtain said control schedule to control the apparatuses accordingly.

7. The system of claim 1, wherein the selection control means is arranged to obtain an input of an operator at a side of the selection control means being remote from the apparatuses, the operator instructing the selection control means to control the apparatuses accordingly.

8. The system of claim 1, wherein the users having substantially the same user preferences are users of the same TV channel.

9. The system of claim 1, wherein the selection control means is arranged to communicate with at least one apparatus for receiving content items by using wireless communication means (250), the wireless communication means comprising at least one mobile phone or remote control unit.

10. The system as claimed in claim 1, wherein the at least one apparatus comprises content presentation means being at least one of a TV set, a video recorder, a DVD player, a home cinema system, a portable audio player, a portable video player or a mobile phone.

11. An apparatus (200) for receiving content items, the apparatus comprising:
means (210, 220) for receiving selection control data to select automatically the same content items as another apparatus for receiving content items, with users of the apparatuses having substantially the same user preferences.

12. A remote control unit (250) for communicating with an apparatus (200) for receiving content items, wherein the remote control unit is arranged to control the apparatus to select automatically the same content items as another apparatus for receiving content items, with users of the apparatuses having substantially the same user preferences.

13. A method of controlling apparatuses for receiving content items, the method comprising the steps (310, 320, 330, 340) of controlling the apparatuses to select automatically the same content items for users having substantially the same user preferences.

14. A computer program product enabling a programmable device, when executing said computer program product, to function as the apparatus as claimed in claim 11.
